(19) United States
(12) Patent Application Publication
(10) Pub. No.: US 2026/0292697 A1
(43) Pub. Date: Sep. 24, 2026

(54) SYSTEM AND APPARATUS FOR SIGNAL MONITORING IN A NETWORK AND A METHOD IN ASSOCIATION THERETO

(71) Applicant: Continental Automotive Technologies GmbH, Hannover (DE)

(72) Inventors: Shravan Kumar KALYANKAR, Singapore (SG); Rikin SHAH, Langen, Hessen (DE); Hojin KIM, Regensburg (DE); Andreas ANDRAE, Frankfurt am Main (DE); Reuben GEORGE STEPHEN, Singapore (SG)

(73) Assignee: Continental Automotive Technologies GmbH, Hannover (DE)

(21) Appl. No.: 19/473,775

(22) PCT Filed: Apr. 12, 2024
(86) PCT No.: PCT/EP2024/059935

§ 371 Date: Oct. 8, 2025

(30) Foreign Application Priority Data
Apr. 14, 2023 (SG) 10202301035S

(51) Int. Cl. H04W 52/02

(52) U.S. Cl. CPC H04W 52/0235

(57) ABSTRACT

A system, an apparatus, a device, and a method for signal monitoring in a network are disclosed. The method includes determining a data transmission schedule in a subsequent cycle; generating data including an indication for signal monitoring based on the data transmission schedule; and transmitting the data including the indication for signal monitoring to a user device in a current cycle.

This application is the U.S. National Phase Application of PCT International Application No. PCT/EP2024/059935, filed Apr. 12, 2024, which claims priority to Singapore Application No. 10202301035S, filed Apr. 14, 2023, the contents of all of which are incorporated herein by reference in their entireties for all purposes.

### FIELD OF INVENTION

The present disclosure generally relates to one or both of a system and a device for signal monitoring in a network and in association with, for example, a base station and/or a User Equipment (UE), usable for communication. The present disclosure further relates a method which can be associated with the system and/or the device.

### BACKGROUND OF INVENTION

Generally, wireless networks provide network connectivity through radio interfaces to mobile communication devices or user equipment (UE), such as smart phones. Energy efficiency and power saving techniques for signal monitoring (e.g. a wakeup signal WuS) by a communication device (or UE) can be helpful in communication networks, for example, a 3rd Generation Partnership Project (3GPP) 5G (fifth generation) New Radio (NR) standard-based telecommunications network.

Current techniques may not address the issue of monitoring a signal by a mobile or user device (or UE) in every cycle, for example a Discontinuous Reception (DRX) cycle. Thus, the current techniques may not facilitate energy efficiency and power saving in an optimal manner.

The present disclosure contemplates that it would be helpful to address or at least mitigate one or more issues in relation to conventional techniques for facilitating energy efficiency and power saving when transmitting a signal to a mobile device (or UE).

### SUMMARY OF THE INVENTION

According to a first aspect of the present invention, there is provided a method for signal monitoring in a network, the method comprising: determining a data transmission schedule in a subsequent cycle; generating data including an indication for signal monitoring based on the data transmission schedule; and transmitting the data including the indication for signal monitoring to a user device in a current cycle.

Advantageously, the method as described herein can have energy savings whereby the energy spent on signal monitoring (e.g. a wakeup signal WuS) and the delay introduced by wakeup effect can be saved.

In an embodiment, the data including the indication for signal monitoring comprises an indication to enable or disable monitoring of the signal.

In an embodiment, the method further includes receiving the data including the indication for signal monitoring to enable monitoring of the signal; and monitoring the signal in the subsequent cycle.

In an embodiment, the method further includes receiving the data including the indication for signal monitoring to disable monitoring of the signal; and receiving downlink data in the subsequent cycle.

In an embodiment, transmitting the data including the indication for signal monitoring to the user device comprises transmitting the data via L1/L2 signaling.

In an embodiment, the data including the indication for signal monitoring further comprises an indication to enable or disable monitoring of the signal in a pre-determined number of subsequent cycles.

In an embodiment, the pre-determined number of subsequent cycles is transmitted via L1/L2 signaling.

In an embodiment, the signal is a Wake-up Signal (WuS) or a Low Power Wake-up Signal (LPWUS).

In an embodiment, the cycle is a Discontinuous Reception (DRX) cycle.

In an embodiment, there is provided a computer program comprising instructions which, when the program is executed by a computer, cause the computer to carry out the method of the first aspect.

In an embodiment, there is provided a computer readable storage medium having data stored therein representing software executable by a computer, the software including instructions, when executed by the computer, to carry out the method of the first aspect.

In an embodiment, there is provided a device for signal monitoring in a network comprising: a first module configured to determine a data transmission schedule in a subsequent cycle; a second module configured to at least one of process and facilitate the method of the first aspect to generate at least one output signal; and a third module configured to communicate at least one output signal, wherein the output signal corresponds to a control signal for signal monitoring by the user device.

In an embodiment, the device may correspond to a base station communicable with an apparatus corresponding to a User Equipment (UE), and wherein the base station corresponds to a Next generation Node B (gNB) configured to communicate the at least one output signal to the UE.

In an embodiment, there is provided a system comprising: at least one apparatus(es); and at least one device(s), wherein the apparatus(es) and the device(s) are capable of being coupled via at least one of wired coupling and wireless coupling.

Advantageously, the system as disclosed herein can have energy efficiency and power saving in a network by enabling or disabling the monitoring of the signal (e.g. WuS or LPWUS) in a cycle (e.g. DRX cycle).

### BRIEF DESCRIPTION OF THE DRAWINGS

Embodiments of the disclosure are described hereinafter with reference to the following drawings, in which:

FIG. 1A shows a schematic diagram illustrating a system for signal monitoring in a network which can include at least one device, according to an embodiment of the invention.

FIG. 1B to 1F show example scenarios in association with the system of FIG. 1A, according to an embodiment of the invention.

FIG. 2 shows a schematic diagram illustrating the device of FIG. 1A in further detail, according to an embodiment of the invention.

FIG. 3 shows a method in association with the system of FIG. 1A, according to an embodiment of the invention.

FIG. 4A to FIG. 4C show schematic diagrams illustrating the flow of information in association with the method of FIG. 3, according to an embodiment of the invention.

### DETAILED DESCRIPTION OF EXEMPLARY EMBODIMENTS

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

In addition, some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, the non-limiting term User Equipment (UE) or wireless device or user device may be used and may refer to any type of wireless device communicating with a network node and/or with another UE in a cellular or mobile communication system. Examples of UE are target device, device-to-device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

In some embodiments, a more general term “network node” may be used and may correspond to any type of radio network node or any network node, which communicates with a User Equipment (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

The present disclosure contemplates an example of power-consuming activities of a user equipment (UE) in a Radio Resource Control (RRC)_CONNECTED mode is to monitor the Physical Downlink Control Channel (PDCCH). In this mode, the UE needs to perform blind detection in its configured control resource sets (CORESETs) to identify whether downlink control information (DCI) is sent to the UE on the PDCCH. On the other hand, the UE may not be scheduled in most PDCCH monitoring occasions and thus, UE monitoring can be a waste of energy.

The present disclosure contemplates discontinuous reception (DRX) may be used to reduce energy consumption. In DRX mode, the UE can start an inactivity timer after a scheduling PDCCH is successfully decoded by the UE. After the inactivity timer expires, the UE can go to sleep following a certain pattern of sleep and OnDurations, i.e. the DRX cycle. The network may only transmit DCI scheduling the UE for a downlink transmission during the OnDuration of the DRX cycle by using such a DRX technique. Therefore, the UE only needs to monitor the PDCCH in those OnDurations and can sleep between the OnDurations in consecutive DRX cycles to save energy. Even though DRX can reduce energy consumption, DRX may require the UE to wake-up frequently, especially when the length of the DRX cycle is relatively short. Also, the UE may waste a significant amount of energy when the OnDuration is relatively long with respect to the duration of the DRX cycle.

The present disclosure contemplates techniques that can reduce unnecessary PDCCH monitoring occasions during the OnDuration of the DRX cycle would be helpful in reducing power consumption. The introduction of a wake-up signal (WuS) or a Low Power Wake-up Signal (LPWUS) can, for example, be considered as one of the efficient solutions to improve UE power consumption. When a WuS (or LPWUS) is employed, the network may send a WuS (or LPWUS) to the UE before the start of the next OnDuration of the DRX cycle if it expects to send DCI scheduling a downlink transmission to the UE. When a WuS (or LPWUS) is implemented, the UE's default behavior is to wake-up and monitor the PDCCH in the next OnDuration of the DRX cycle only when a WuS (or LPWUS) is detected. If no WuS (or LPWUS) is detected, the UE remains in a sleep mode during the next OnDuration. The WuS (or LPWUS) itself may be sent by the network when there is data in the buffer to be transmitted to the UE. By allowing the UE to conduct PDCCH monitoring only when there will be a transmission on the Physical Downlink Shared Channel (PDSCH), the UE energy consumption can be significantly reduced. In addition, WuS (or LPWUS) monitoring can be set to be more power-efficient compared to that of the normal PDCCH monitoring and thus, may further improve the UE energy efficiency.

The present disclosure contemplates the UE may not always successfully detect or decode the WuS (or LPWUS) in the WuS monitoring occasions even when the network sends a WuS (or LPWUS) to wake-up the UE for the next OnDuration. In this case, the UE remains in a sleep state and may miss the scheduling PDCCH from the network during the OnDuration. Consequently, the scheduled data transmission on the PDSCH may not be received by the UE. A “missed” WuS (or LPWUS) can increase latency and reduces throughput. When the UE misses the PDSCH transmission from the network for several occasions and fails to provide expected acknowledgement (ACK) or negative acknowledgement (NACK) feedback, a radio link failure (RLF) may be declared which can result in a loss and disruption of service. Therefore, the UE may need to reestablish the connection, which can use a significant amount of power. The potential power saving, therefore, can be significantly diluted due to “missed” WuS (or LPWUS) detection.

The present disclosure further contemplates the UE may need to wake-up twice when data is transmitted from the network (or base station) to the UE, i.e., once to monitor the WuS (or LPWUS) monitoring occasions and a second time during the next OnDuration of the DRX cycle. When WuS (or LPWUS) is not implemented, the UE may need only to wake-up once, i.e., during the OnDuration of the DRX cycle. When there are frequent data transmissions from the network to the UE, the power saving gain from using the WuS (or LPWUS) can be significantly reduced and may in some circumstances increase power consumption. In addition, the UE may not be able to return to a deep sleep in the gap between the WuS (or LPWUS) monitoring occasion and the OnDuration. The UE may need to remain awake, or return to a shallower sleep state, which can consume more power than a deep sleep.

The present disclosure contemplates a WuS (Wake-up Signal) or a Low Power Wake-up Signal (LPWUS) mechanism may be introduced to improve energy efficiency of the UE (User Equipment). The UE can state in sleep mode and switches off the main radio, until a WuS (or LPWUS) signal is detected at the secondary radio (WuS receiver). The main radio may be triggered to switch on after the WuS receiver detects a WuS (or LPWUS) signal.

The present disclosure contemplates the WuS receiver can be a low complex and low power consuming component of a UE and the main radio can be a high energy consuming component of the UE. The main radio may be switched off (sleep mode) as much as possible to reduce the energy consumption at the UE.

The present disclosure contemplates the possibility that the UE may not be able to detect a Wake-up signal (WuS) or a Low Power Wake-up Signal (LPWUS) at the edge of a cell (or base station) coverage. The present disclosure further contemplates if the WuS (or LPWUS) is not detected at the UE, the UE may continue to be in a sleep state. Therefore, the gNB (or base station or cell) may not perform a data exchange with the UE until a successful WuS (or LPWUS) detection at the UE.

The present disclosure contemplates that in order to provide the low power consumption and power saving gains, the sensitivity of Low Power Wake-up Receiver (LPWUR) may be worse than that of main radio and the coverage loss should be investigated. For example, coverage estimates for the Low Power Wake-up Signal (LPWUS) design with different bandwidth/duration, miss-detection and false alarm rate analysis and impact of SIR, frequency error, etc. can be investigated.

The present disclosure further contemplates that each WuS may be associated with one DRX (Discontinuous Reception) cycle such that the UE monitors the WuS for every DRX cycle. The UE (or user device) may monitor a signal (e.g. WuS) in every DRX cycle which may lead to higher energy consumption when every DRX cycle has a downlink (DL). The present disclosure thus contemplates the possibility of the UE not monitoring WuS in every DRX cycle and that a new indication can be proposed from the network (or base station or gNB) side as to whether the UE has to monitor the next WuS.

In the above manner, a method can be provided on signal (e.g. WuS or LPWUS) monitoring to a user device (or UE), in accordance with an embodiment of the invention. Power saving and energy consumption efficiency can therefore possibly be facilitated in the network, in accordance with an embodiment of the invention.

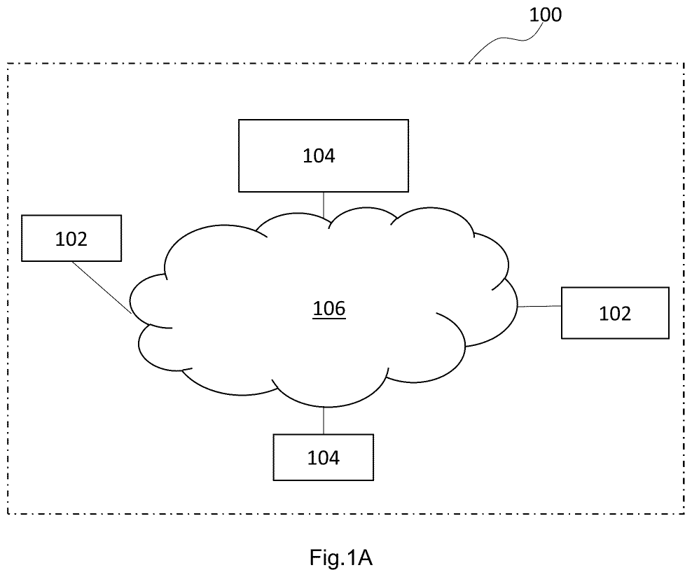

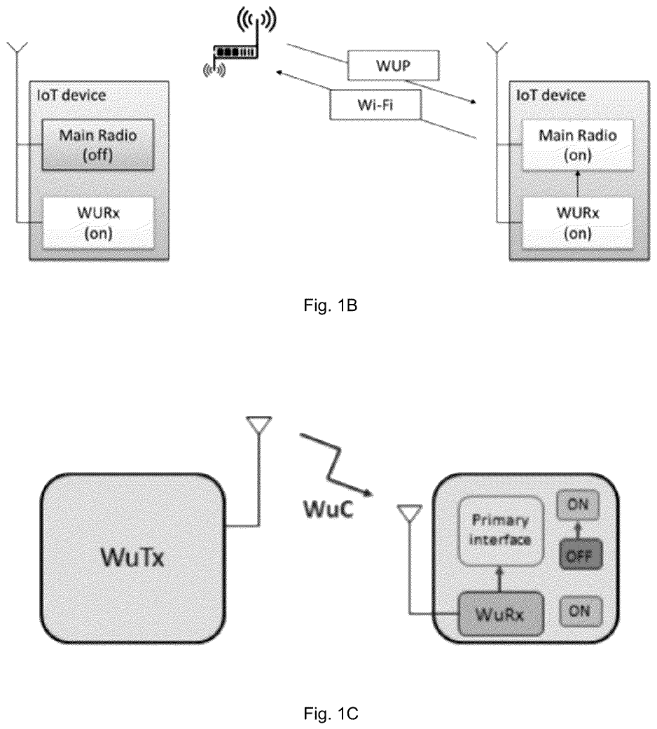

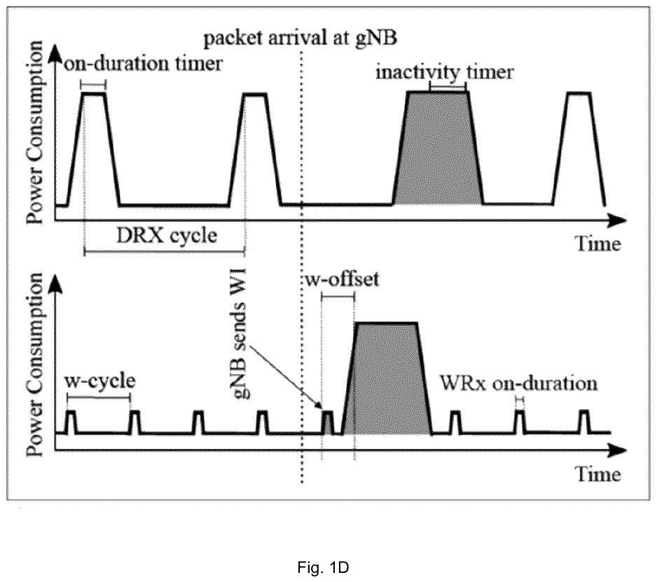

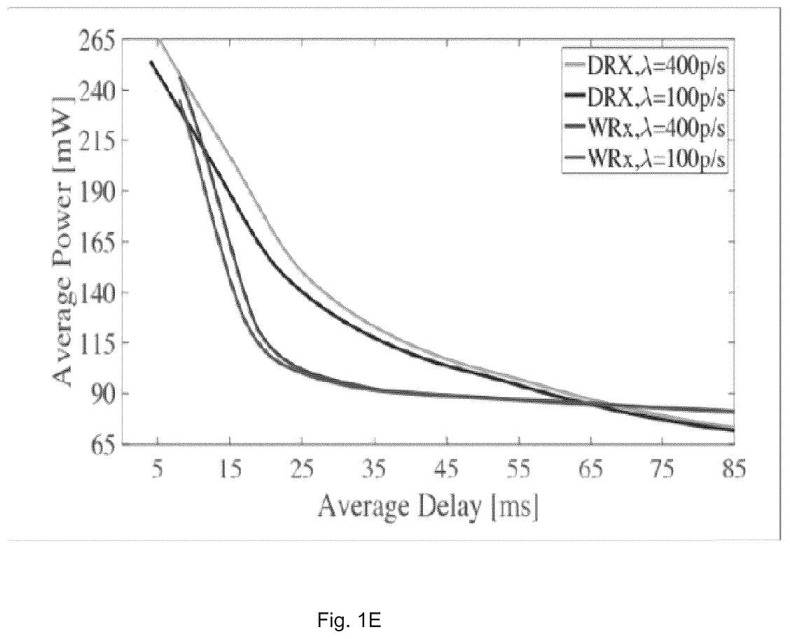

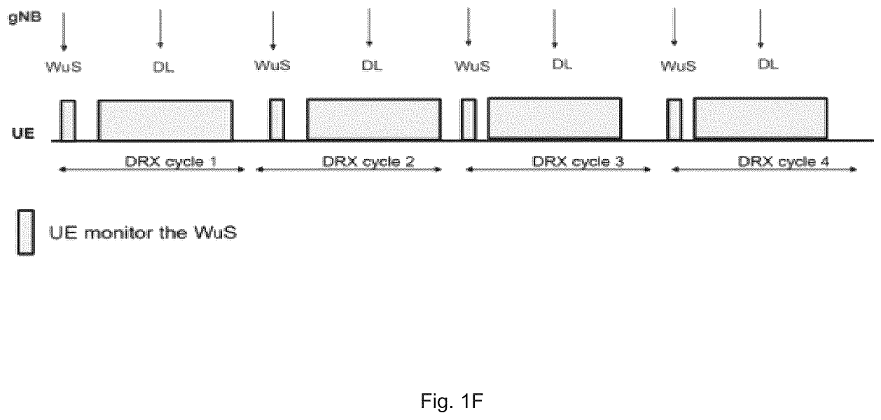

The foregoing will be discussed in further detail with reference to FIG. 1 to FIG. 4 hereinafter.

Referring to FIG. 1A, a schematic diagram illustrating a system 100 for signal monitoring in a network is shown, according to an embodiment of the invention. The system 100 can, for example, be suitable for facilitating energy and improve power efficiency, in accordance with an embodiment of the invention.

As shown, the system 100 can include one or more apparatuses 102, at least one device 104 and, optionally, a communication network 106, in accordance with an embodiment of the invention.

The apparatus(es) 102 can be coupled to the device(s) 104. Specifically, the apparatus(es) 102 can, for example, be coupled to the device(s) 104 via the communication network 106, in accordance with an embodiment of the invention.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the invention.

The apparatus(es) 102 can, for example, be associated with or correspond to or include one or more user equipment (UE) which can carry one or more computers, in accordance with an embodiment of the invention. For example, an apparatus 102 can correspond to a UE or a user device carrying at least one computer (e.g. an electronic device or module having computing capabilities such as an electronic mobile device which can be carried into a vehicle or an electronic module which can be installed in a vehicle, in accordance with an embodiment of the invention) which can be configured to perform one or more processing tasks in association with the UE, in accordance with an embodiment of the invention.

In an embodiment, the apparatus(es) 102 can, for example, be configured to receive one or more input signals and perform at least one processing task based on the input signal(s) in a manner to generate one or more output signals. The input signal(s) can, for example, be communicated from the device(s) 104 and received by the apparatus(es) 102, in accordance with an embodiment of the invention.

The device(s) 104 can, for example, be associated with/correspond to at least one base station, where the at least one base station can be a Next Generation Node B (gNB). Moreover, the device(s) 104 can, for example, be configured to carry/be associated with/include one or more computers (e.g., an electronic device/module having computing capabilities) which can, for example, be configured to perform one or more processing tasks in association with the base station. The device(s) 104 can be configured to receive one or more input signals which can be communicated from the apparatus(es) 102, in accordance with an embodiment of the invention. The device(s) 104 can, for example, perform one or more processing tasks in association with dynamic/adaptive/gradual control on the input signal(s) in a manner so as to generate at least one output signal. This will be discussed later in further detail in the context of an example scenario, in accordance with an embodiment of the invention.

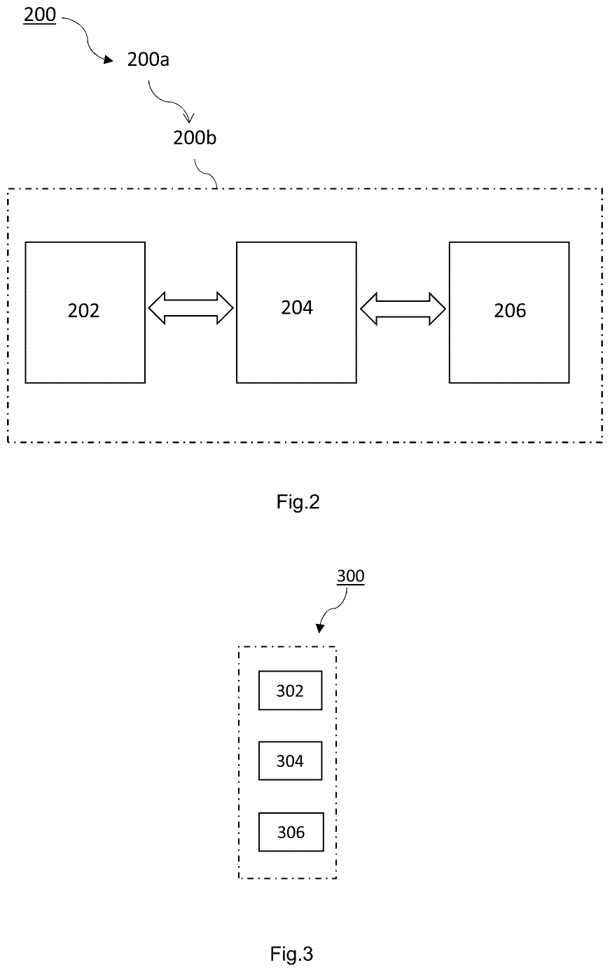

The input signal can be associated with a data transmission schedule in a subsequent cycle to a user device (or UE). Specifically, the data transmission schedule may include future downlink (DL) data that is scheduled in the next or subsequent Discontinuous Reception (DRX) cycle. As a possible option, the output signal(s) can, for example, be communicated from the device(s) 104, in accordance with an embodiment of the invention. The output signal may correspond to a control signal for signal (e.g. WuS or LPWUS) monitoring by the user device (or UE). The apparatus(es) 102 and device(s) 104 will be discussed later in further detail with reference to FIG. 2, according to an embodiment of the invention.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

The device(s) 104 can, for example, be configured to generate (and communicate) the output signal(s) to the apparatus(es) 102, in accordance with an embodiment of the invention. Accordingly, the device(s) 104 can generate a control signal for signal (e.g. WuS or LPWUS) monitoring by the user device (or UE) to the apparatus(es) 102. This will be discussed, in accordance with an embodiment of the invention, in the context of example scenarios with reference to FIG. 1B to FIG. 1E, hereinafter.

FIG. 1B to 1F show example scenarios in association with the system of FIG. 1A, according to an embodiment of the invention. Specifically, FIG. 1B and FIG. 1C show examples of different embodiments of a Wake-up Signal (WuS) transmission. The example embodiment of FIG. 1B can be a WuS transmission framework for a wireless communication network, for example IEEE 802.11ba. In this embodiment, a wakeup pattern (WUP) may be transmitted to one or more user devices or User Equipment (UE), which can be for example, an Internet-of-Things (IoT) device. Each of the user device (or IoT device) can be in communication with a server or a base station (e.g. a gNB) via Wifi and may include a wake-up receiver (WuRx) or a Low-power wake-up receiver (LPWUR) that can be turned on. In accordance with an embodiment of the present invention, the IoT device (or UE or user device) that is receiving the WUP can turn on its main radio while the IoT device (or UE or user device) that is not receiving the WUP can have its main radio turned off.

The example embodiment of FIG. 1C can be a WuS transmission framework for another wireless communication network, for example 3GPP. In this embodiment, a low-power wake-up transmitter (WuTx) may be in communication with a user device or UE (e.g. IoT device) and sends the WuS to the WuRx of the user device (or UE). The WuTx may be installed in a server or a base station (e.g. gNB) or may also be installed in another user device or UE (e.g. IoT device).

In an implementation, the WuRx may be a front-end device with low power active or passive device to trigger the Radio Frequency (RF) and baseband processors of a User Equipment (UE) receiver. In an example embodiment, the wake-up receiver (WuRx) can be a low-complexity and low-cost device in addition to the new radio (NR) receiver. The wake-up signal (WuS) or low power wake-up signal (LPWUS) can be a waveform detected by the wakeup receiver (WuRx) such that the wakeup signal (WuS) or low power wake-up signal (LPWUS) can be operated at the same or different frequency band of the NR operation band, in accordance with an embodiment of the invention.

In an embodiment, Discontinuous Reception (DRX) can allow the UE (or user device) to reduce its energy consumption by turning on sleep mode for a certain period, while decoding physical downlink control channel (PDCCH) only in a short active period. A Wake-Up Signal (WuS) or a Low Power Wake-up Signal (LPWUS) detection can include a wake-up receiver (WuRx) which is a standalone receiver or as a submodule in main receiver. In every wake-up cycle (w-cycle), the WuRx monitors a set of specified subcarriers for a short duration of time to determine whether it receives a wake-up signal. The network then informs the UE to decode the PDCCH by using the WuS or LPWUS.

In an embodiment, UE (or user device) power consumption and potential power saving gain may include a lowest power consumption device that can be a baseline for comparison, where the power consumption of a Low-Power Wave-up Receiver (LPWUR) may be in uW. According to this embodiment, such an approach can advantageously extend a battery life of the UE (or user device) whereby performance benefits may be achieved by enabling a battery life that spans the useful life cycle of an enhanced UE (or user device).

In another embodiment, the sensitivity of LPWUR can be worse than that of a main radio in order to provide low power consumption and power saving gains. Coverage loss can be overcome by having coverage estimates for a Low-Power Wake-up Signal (LPWUS) design with different bandwidth/duration, miss-detection and false alarm rate analysis and analyzing the impact of SIR, frequency error, etc.

FIG. 1D shows examples of graphs of power consumption against time. The top graph in FIG. 1D shows an example embodiment of representative power consumption profiles of Discontinuous Reception (DRX) cycle while the bottom graph shows an example embodiment of representative power consumption profiles of WuS. The shaded areas of each graph can indicate power consumption under scheduled physical downlink control channel (PDCCH). Each WuS can be associated with one DRX cycle, the W-offset may indicate Wakeup offset and W-cycle may indicate Wakeup cycle.

In an embodiment, a network impact may include overhead such as a fraction of timeslots used for WuS or LPWUS that can have impact on the network energy efficiency. Latency can also be analyzed on whether the UE should still monitor PO after wakeup as well as the time taken for the LPWUS. Analysis on mobility may include whether the main receiver needs to perform cell search after the main receiver is turned on.

FIG. 1E shows a graph of average power (mW) against Average Delay (ms) of a simulation-based power-delay operating characteristics curves for DRX and WS under two different mean packet arrival rates. The graph can represent the total energy consumption of the UE (or user device) during a 10-second session for corresponding packet arrival rates. The present disclosure thus contemplates that DRX methods can work better for applications with longer delay tolerance while WuS methods can be suitable for applications which can accept 15 ms to 35 ms delay tolerance.

FIG. 1F shows an example embodiment of WuS and DL data transmissions in various Discontinuous Reception (DRX) cycles between a gNB (or base station) and a UE (or user device). In this embodiment, the gNB (or base station) transmits WuS and DL data to the UE (or user device) and the UE (or user device) may monitor the WuS in every DRX cycle which can lead to higher energy consumption when every DRX cycle has a downlink (DL).

The above-described aspect(s) of the system 100 of the present invention can also apply analogously (all) the aspect(s) of a below described apparatus 102 and device 104 of the present invention. Likewise, all below described aspect(s) of the apparatus 102 and device 104 of the invention can also apply analogously (all) the aspect(s) of above-described system 100 of the invention.

The aforementioned device(s) 104 or base station will be discussed in further detail with reference to FIG. 2 hereinafter.

Referring to FIG. 2, a schematic diagram illustrating a device 104 is shown in further detail in the context of an example implementation 200, according to an embodiment of the invention.

In the example implementation 200, the device 104 can correspond to an electronic module 200a. The electronic module 200a can, in one example, correspond to a base station or a cell, in accordance with an embodiment of the invention. In another example, the electronic module 200a can correspond to an electronic device which can be installed/mounted in the base station or the cell, in accordance with an embodiment of the invention.

It is contemplated that the electronic module 200a can be capable of performing one or more processing tasks in association with adaptive/dynamic/gradual control related processing, in accordance with an embodiment of the invention.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the invention.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the invention. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the invention.

In one example, the first module 202 can correspond to a hardware-based receiver which can be configured to receive one or more input signals. The input signal(s) can, for example, be communicated from the apparatus(es) 102 (or user device or UE), in accordance with an embodiment of the invention.

The second module 204 can, for example, correspond to a hardware-based processor which can be configured to perform one or more processing tasks (e.g., in a manner so as to generate one or more output signals) as will be discussed later in further detail with reference to FIG. 3, in accordance with an embodiment of the invention.

The third module 206 can correspond to a hardware-based transmitter which can be configured to communicate one or more output signals from the electronic module 200a. The output signal(s) can, for example, include one or more instructions/commands/control signals in association with the aforementioned dynamic/adaptive/gradual control configuration/determination strategy so as to facilitate efficiency (e.g., power/energy efficiency and/or communication efficiency), in accordance with an embodiment of the invention. For example, the output signal(s) can be a control signal(s) for signal (e.g. WuS or LPWUS) monitoring by a user device (or UE).

The present disclosure contemplates the possibility that the first and second modules 202, 204 can be an integrated software-hardware based module, for example, an electronic part which can carry a software program or algorithm in association with receiving and processing functions or an electronic module programmed to perform the functions of receiving and processing. The present disclosure further contemplates the possibility that the first and third modules 202, 206 can be an integrated software-hardware based module, for example an electronic part which can carry a software program or algorithm in association with receiving and transmitting functions or an electronic module programmed to perform the functions of receiving and transmitting. The present disclosure yet further contemplates the possibility that the first and third modules 202, 206 can be an integrated hardware module, for example a hardware-based transceiver, capable of performing the functions of receiving and transmitting.

The device 104 (or base station or gNB) can, for example, be further configured to process the input signal(s), as will be discussed later in further detail with reference to FIG. 3, in a manner so as to generate one or more output signals in a manner so as to facilitate efficiency, for example power efficiency or energy efficiency, in accordance with an embodiment of the invention. In one specific example, the output signal(s) can include one or more control signals to facilitate some form of dynamic/adaptive/gradual control configuration/determination strategy so as to facilitate efficiency, for example power efficiency or energy efficiency, in accordance with an embodiment of the invention. For example, the output signal(s) can be a control signal(s) for signal (e.g. WuS or LPWUS) monitoring by a user device (or UE).

In an embodiment, the schematic diagram of FIG. 2 may also illustrate an apparatus 102 in the context of the example implementation 200, according to an embodiment of the invention.

In particular, the example implementation 200 together with its modules 200a, 200b, 202, 204 and 206 as described above may correspond to an apparatus 102 such as a User Equipment (UE) or user device. For example, the electronic module 200a having the casing 200b, the first module 202, the second module 204 and the third module 206 may correspond to a mobile device (or UE) which can, for example, be carried into the vehicle by a user, in accordance with an embodiment of the invention. In another example, the electronic module 200a can correspond to an electronic device which can be installed/mounted in the vehicle, in accordance with an embodiment of the invention. In this regard, the electronic module 200a can be considered to be carried by the vehicle (e.g., either carried into the vehicle by a user or installed/mounted in the vehicle). In an example, the first module 202 can correspond to a hardware-based receiver which can be configured to receive one or more input signals which can, for example, be communicated from the device 104 (or base station or gNB), in accordance with an embodiment of the invention.

The above-described aspect(s) of the apparatus 102 and device 104 of the present invention can also apply analogously (all) the aspect(s) of a below described processing/communication method of the present invention. Likewise, all below described aspect(s) of the method of the invention can also apply analogously (all) the aspect(s) of above described apparatus 102 and device 104 of the invention. It is to be appreciated that these remarks apply analogously to the earlier discussed system 100 of the present disclosure.

Referring to FIG. 3, a method 300 (or a communication method) for signal (e.g. a WuS or LPWUS) monitoring in association with the system 100 is shown, according to an embodiment of the invention.

The method 300 can, for example, be suitable for facilitating energy efficiency, network optimization and power saving in accordance with an embodiment of the invention.

The method 300 can include any one of an input step 302, a processing step 304 and an output step 306, or any combination thereof, in accordance with an embodiment of the invention.

In an embodiment, the processing method 300 can include the input step 302. In another embodiment, the processing method 300 can include the input step 302 and the processing step 304. In another embodiment, the processing method 300 can include the input step 302, the processing step 304 and the output step 306. In yet another embodiment, the processing method 300 can include the processing step 304 and one or both of the input step 302 and the output step 306. In yet a further embodiment, the processing method 300 can include the input step 302, the processing step 304 and the output step 306. In yet a further additional embodiment, the processing method 300 can include the processing step 304. In yet another further additional embodiment, the processing method 300 can include any one of or any combination of the input step 302, the processing step 304 and the output step 306 (i.e., the input step 302, the processing step 304 and/or the output step 306).

With regard to the input step 302, one or more input signal(s) can be received. For example, the input signal(s) can be communicated from the apparatus 102 and can be received by the device 104, in accordance with an embodiment of the invention. In another example embodiment, the input signal(s) may be communicated from a second or different device.

The input step 302 can include receiving at least one input signal associated with a data transmission schedule in a subsequent cycle, for example a subsequent Discontinuous Reception (DRX) cycle. In an embodiment, the input signal(s) may be generated by the apparatus 102 and/or a second device and transmitted to the device 104 to advance to the processing step 304.

With regard to the processing step 304, at least a processing task can be performed in association with the received input signal(s) in a manner so as to generate one or more output signals, in accordance with an embodiment of the invention.

The processing step 304 may include at least one of: determining a data transmission schedule in a subsequent cycle; generating data including an indication for signal monitoring based on the data transmission schedule; and transmitting the data including the indication for signal monitoring to a user device in a current cycle. The data including the indication for signal monitoring may include an indication to enable or disable monitoring of the signal. For example, the base station or network (e.g. gNB) may determine that future downlink (DL) data may be scheduled for the next cycle and sends the data and indication to the UE (or user device) in the current cycle. The signal may be a Wake-up Signal (WuS) or a Low Power Wake-up Signal (LPWUS) and the cycle can be a Discontinuous Reception (DRX) cycle.

The processing step 304 may further include receiving the data including the indication for signal monitoring to enable monitoring of the signal and monitoring the signal in the subsequent cycle. The processing step 304 may also include receiving the data including the indication for signal monitoring to disable monitoring of the signal; and receiving downlink data in the subsequent cycle. Based on such an indication, the UE (or user device) may not monitor the next WuS and will be awake (main radio is on) during the DRX cycle to receive a downlink data from the network (or base station or gNB).

In an embodiment, transmitting the data including the indication for signal monitoring to the user device comprises transmitting the data via L1/L2 signaling, where L1 may indicate Layer 1 Physical Layer while L2 may indicate Layer 2 MAC Layer. In an embodiment, the data including the indication for signal monitoring may further include an indication to enable or disable monitoring of the signal in a pre-determined number of subsequent cycles. The base station (or gNB) may be configured to pre-determine the number subsequent cycles N and may subsequently transmit the pre-determined number of subsequent cycles N via L1/L2 signaling, in accordance with an embodiment of the invention. For example, if N is one, then the user device (or UE) only monitors the signal in the next cycle. In another example, if N is two, the user device (or UE) only monitors the signal in the next two cycles. This can advantageously improve power saving at the user device (or UE).

With regards to the output step 306, the output signal(s) can, for example, be communicated, as an option, in accordance with an embodiment of the invention. For example, the output signal(s) can optionally be communicated from the device 104. In a more specific example, the output signal(s) can optionally be communicated from the device 104 to one or both of at least apparatus 102, in accordance with an embodiment of the invention.

The present disclosure further contemplates a computer program (not shown) which can include instructions which, when the program is executed by a computer (not shown), cause the computer to carry out the input step 302, the processing step 304 and/or the output step 306 as discussed with reference to the method 300. For example, the computer program can include instructions which, when the program is executed by a computer, cause the computer to carry out the input step 302 and/or the processing step 304, in accordance with an embodiment of the invention.

The present disclosure yet further contemplates a computer readable storage medium (not shown) having data stored therein representing software executable by a computer (not shown), the software including instructions, when executed by the computer, to carry out the input step 302, the processing step 304 and/or the output step 306 as discussed with reference to the method 300. For example, the computer readable storage medium can have data stored therein representing software executable by a computer, the software including instructions, when executed by the computer, cause the computer to carry out the input step 302 and/or the processing step 304, in accordance with an embodiment of the invention.

Further in view of the foregoing, it is appreciable that the present disclosure generally contemplates a device 104 for signal monitoring in a network which can include a first module 202, a second module 204 and/or a third module 206.

The first module 202 can be configured to receive one or more input signals. The input signal(s) can, for example, be associated with a data transmission schedule to the UE (or user device) in a subsequent cycle.

The second module 204 can be configured to process and/or facilitate processing of the input signal(s) according to the method 300 as discussed earlier to generate one or more output signals.

The third module 206 can be configured to communicate one or more output signals. The output signal(s) can, for example, correspond to one or more control signals for signal (e.g. WuS or LPWUS) monitoring by the user device (or UE).

In one embodiment, the apparatus 102 can correspond to a User Equipment (UE) which can communicate with a device 104 corresponding to a base station. The base station can, for example, correspond to a Next generation Node B (gNB) which can be configured to communicate one or more signals (e.g., output signal(s)) to the UE.

Yet further in view of the foregoing, it is appreciable that the present disclosure generally contemplates a system 100 which can include one or more apparatuses 102 and one or more devices 104. The apparatus(es) 102 and the device(s) 104 can, for example, be capable of being coupled via wired coupling and/or wireless coupling.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the possibility of the output signal(s) being communicated from the device(s) 104 was discussed. It is appreciable that the output signal(s) need not necessarily be communicated from the device(s) 104. Specifically, the possibility that the output signal(s) need not necessarily be communicated outside of the device(s) 104 is contemplated, in accordance with an embodiment of the invention. More specifically, the output signal(s) can, for example, correspond to internal command(s)/instruction(s) (e.g., communicated only within an apparatus 102) for adaptively controlling operational configuration of an apparatus 102, in accordance with an embodiment of the invention.

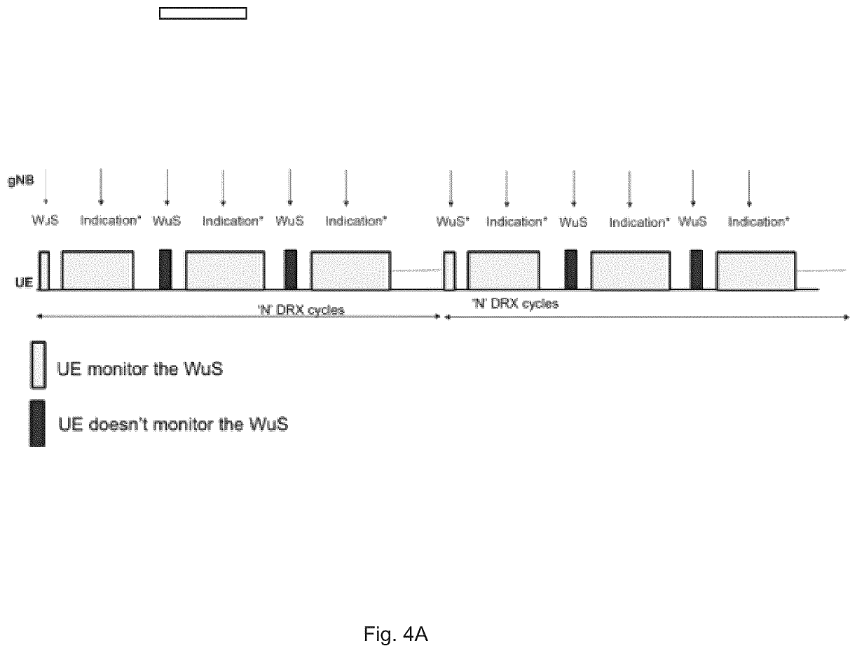

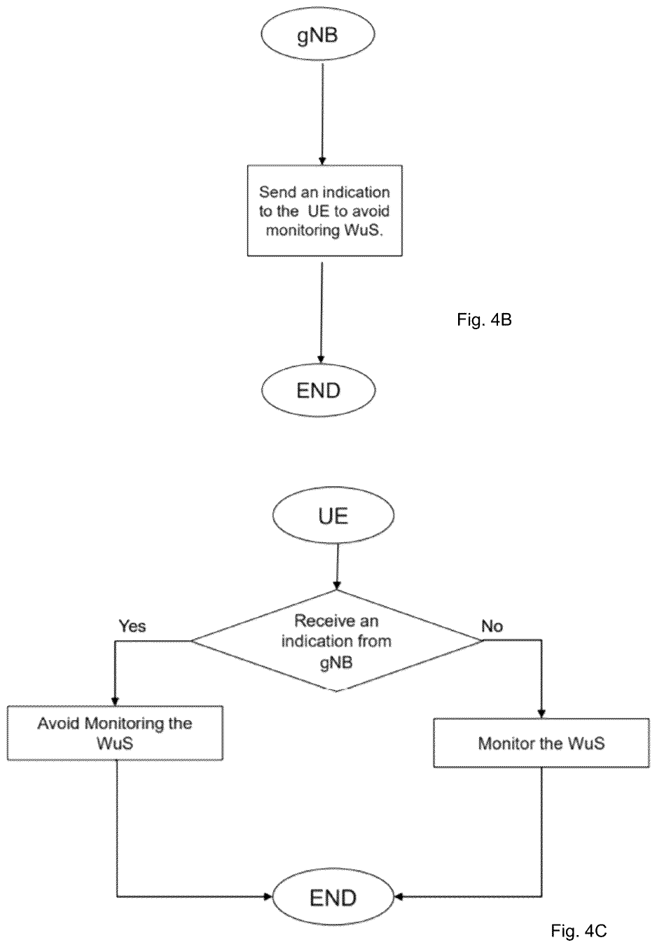

FIG. 4A to FIG. 4C show schematic diagrams illustrating the flow of information in association with the method of FIG. 3, according to various embodiments of the invention.

FIG. 4A shows an example embodiment of selective signal (e.g. Wake-up Signal WuS or Low Power Wake-up Signal LPWUS) monitoring in various Discontinuous Reception (DRX) cycles. In the example embodiment, the UE (or user device) monitors “N” PO for every WuS that is received. The network (or base station or gNB) may transmit an indication to the UE (or user device), for example in the first cycle, whether to monitor the next WuS. If the indication is not to monitor the next WuS, the UE (or user device) does not monitor the WuS in the second cycle and may only receive downlink (DL) data.

In an alternate embodiment, the network (or base station or gNB) may transmit an indication to the UE (or user device), for example in the first cycle, not to monitor the WuS in the next two DRX cycles (where N is equal to two). The UE (or user device) receives the indication and does not monitor for the WuS in the next two cycles. At the third DRX cycle, the UE (or user device) may start monitoring the WuS.

In the example context as shown in FIG. 4B, a gNB (or base station) may be configured to send an indication to the UE (or user device) to avoid monitoring WuS. In the example context as shown in FIG. 4C, the UE (or user device) can be configured to receive an indication from the gNB (or base station). If the indication is to disable monitoring of the signal, the UE (or user device) avoids monitoring the WuS in the next cycle. On the other hand, if the indication is to enable monitoring of the signal., the UE (or user device) continues monitoring the WuS in the next cycle. Alternatively, if the UE (or user device) does not receive any indication, it may continue monitoring the WuS in the next cycle.

In the foregoing manner, various embodiments of the disclosure are described for addressing at least one of the foregoing disadvantages. Such embodiments are intended to be encompassed by the following claims and are not to be limited to specific forms or arrangements of parts so described and it will be apparent to one skilled in the art in view of this disclosure that numerous changes and/or modification can be made, which are also intended to be encompassed by the following claims.

### ABBREVIATIONS

ACK: acknowledgement
AGC: automatic gain control
BSR: buffer status report
BWP: bandwidth part
CG: configured grant
CS-RNTI: configured scheduling radio network temporary identifier
DCI: downlink control information
DRX: Discontinuous Reception
GP: guard period
HARQ: hybrid automatic repeat request
LPWUS: Low Power Wake-up Signal
LPWUR: Low Power Wake-up Receiver
NACK: negative acknowledgement
NDI: new data indicator
NR: new radio
OFDM: orthogonal frequency-division multiplexing
PDCCH: physical downlink control channel
PRB: physical resource block
PRS: positioning reference signal
PSBCH: physical SL broadcast channel
PSCCH: physical SL control channel
PSFCH: physical SL feedback channel
PSSCH: physical SL shared channel
RAN: radio access network
RB: resource block
RP: resource pool
RRC: radio resource control
SCI: sidelink control information
SL: sidelink
SPCI: SL positioning Control Information
S-PSS: SL primary synchronization signal
SR: scheduling request
S-SS: SL synchronization signals
S-SSB: SL synchronization signal block
S-SSS: SL secondary synchronization signal
SL-RNTI: sidelink radio network temporary identifier
TB: transmission block
UE: user equipment
UL: uplink
WID: work item description
WuS: Wake-up Signal

1. A method for signal monitoring in a network, the method comprising:
determining a data transmission schedule in a subsequent cycle;
generating data including an indication for signal monitoring based on the data transmission schedule; and
transmitting the data including the indication for signal monitoring to a user device in a current cycle.

2. The method according to claim 1, wherein the data including the indication for signal monitoring comprises an indication to enable or disable monitoring of the signal.

3. The method according to claim 2, further comprising:
receiving the data including the indication for signal monitoring to enable monitoring of the signal; and
monitoring the signal in the subsequent cycle.

4. The method (309, according to claim 2, further comprising:
receiving the data including the indication for signal monitoring to disable monitoring of the signal; and
receiving downlink data in the subsequent cycle.

5. The method according to claim 1, wherein transmitting the data including the indication for signal monitoring to the user device comprises transmitting the data via L1/L2 signaling.

6. The method according to claim 1, wherein the data including the indication for signal monitoring further comprises an indication to enable or disable monitoring of the signal in a pre-determined number of subsequent cycles.

7. The method according to claim 6, wherein the pre-determined number of subsequent cycles is transmitted via L1/L2 signaling.

8. The method according to claim 1, wherein the signal is a Wake-up Signal (WuS) or a Low Power Wake-up Signal (LPWUS).

9. The method according to claim 1, wherein the cycle is a Discontinuous Reception (DRX) cycle.

10. A computer program comprising instructions which, when the program is executed by a computer, cause the computer to carry out the method according to claim 1.

11. A computer readable storage medium having data stored therein representing software executable by a computer, the software including instructions, when executed by the computer, to carry out the method according to

12. A device for signal monitoring in a network comprising:
a first module configured to determine a data transmission schedule in a subsequent cycle;
a second module configured to at least one of process and facilitate the method of claim 1 to generate at least one output signal; and
a third module configured to communicate at least one output signal, wherein the output signal corresponds to a control signal for signal monitoring by the user device.

13. The device according to claim 12,
wherein the device corresponds to a base station communicable with an apparatus corresponding to a User Equipment, and
wherein the base station corresponds to a Next generation Node B configured to communicate the at least one output signal to the UE.

14. A system comprising:
at least one device according claim 12;
at least one apparatus corresponding to a User Equipment (UE), wherein a base station corresponds to a Next generation Node B (qNB) configured to communicate the at least one output signal to the UE, and
wherein the apparatus and the device are capable of being coupled via at least one of wired coupling and wireless coupling.
